(19) United States
(12) Patent Application Publication
(10) Pub. No.: US 2009/0144733 A1
(43) Pub. Date: Jun. 4, 2009

(54) VIRTUAL MACHINE SYSTEM AND CONTROL METHOD OF VIRTUAL MACHINE SYSTEM

(76) Inventors: Eiichiro Oiwa, Tone (JP); Naoya Hattori, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/323,610

(22) Filed: Nov. 26, 2008

(30) Foreign Application Priority Data
Nov. 30, 2007 (JP) 2007-310812

(51) Int. Cl. G06F 9/455

(52) U.S. Cl. 718/1

(57) ABSTRACT

A virtual machine system and a control method for the virtual machine system. An instruction causing a protection exception is analyzed by the protection exception process by accessing at least a virtual device, while judging whether the optimum emulated code is executed for each function on the virtual device. If the optimum emulated code is executable, the cause of the protection exception is stored in a memory and the optimum emulated code is executed, while at the same time judging whether the cause stored in the memory is usable for the next and subsequent protection exception processes. If the cause is so usable, the optimum emulated code is executed while omitting process having a large processing amount thereby to reduce the amount of the protection exception process. The stored contents of the cause of the protection exception are compared with the contents of the instruction analyzed, and ife the cause held is not reusable, the cause of the protection exception is deleted.

### BACKGROUND OF THE INVENTION

This invention relates to a virtual machine system and a control method of the virtual machine system, or in particular, to a virtual machine system and a control method of the virtual machine system for reducing the protection exception handling required at the time of reading from or writing into a protected address of the virtual machine system.

With the increase in the number of elements adapted to be integrated as an integrated circuit and the development of the high-density packaging technique for coupling them in recent years, the amount of the computation resources such as the number of processors, the number of I/O devices and the memory capacity that are accommodated in a housing of each real machine tend to increase. Also, the technique of coupling the housings of plural real machines through a network and handling them as a single real machine is also making such a progress that the computation resources accommodated in each real machine are ever on the increase. This large-scale real machine with many computation resources accommodated as a single real machine requires a longer time before becoming operable after power on than the real machine having fewer computer resources. The power supply of the large-scale real machine, therefore, tends to be desirably left switched on.

In order to use this large-scale real machine efficiently, the technique is extending to construct a virtual machine system by LPAR (Logical PARtition) as a method of dividing the resources of one real machine virtually into plural sections. An independent OS is operable as a virtual machine in each of the sections into which the resources are logically partitioned. The power supply of the logically partitioned real machines is kept on, and each LPAR can be virtually switched on or off. In this way, the operating efficiency and availability of the node resources of the large-scale real machine can be improved by use of the logical partition.

The virtual machine system described above requires a virtual machine manager to secure the independence of a given virtual machine from the other virtual machines in the same real machine. This virtual machine manager or manager program requires the control function and the virtualization function for permitting each independent virtual machine to dedicate or share the use of the processors, the memories and the I/O devices of the real machines dividedly.

The device virtualization described above is realized by using a processor capable of protecting a specified address space. In the processor having the protection function, an exception occurs and the virtual machine manager is executed as an exception handling program in the case where the read or write operation is performed from or into a protected region of the access space. This protection exception processing program for protection exception realizes the device virtualization. To implement a virtual device, the exception handler recognizes a read/write instruction, decodes its instruction and executes the emulated code equivalent to the execution of the instruction in real machine.

Incidentally, the conventional techniques for the control operation to realize the virtual device described above are described in, for example, JP-A-2003-167758 and U.S. Patent Application Publication No. 2006-085543 or JP-A-2006-085543.

In a certain type of processor, the register of an interrupt controller is assigned to an address region (physical frame) determined in the physical memory address space. By writing and reading each address thus assigned, the read and write operation of the register are performed. In virtualizing an interrupting device, the physical frame to which the register of the interrupt controller is assigned is related to a virtual address region (page) adapted for access protection, and by designating this page for protection, a part of the write/read exception process is executed by the virtual machine manager. As the result of this exception processing, the interrupt controller is virtualized. The read/write operation from/into the register of the interrupt controller, therefore, requires the exception processing to recognize the read/write instruction, decode its instruction and execute the emulated code. The register for the interrupt handling program to report the completion of the interrupt handling is also assigned to the same protected region, and therefore, similarly requires the process of specifying the instruction and executing the emulated instruction.

As described above, the conventional technique using the control method for device virtualization by the protection exception handling including the assignment of the protected region requires the process of specifying an instruction that has caused the exception and executing the emulated code equivalent to the execution of the particular instruction in the real machine. This poses the problem of an increased processing amount as compared with the device not virtualized. Another problem posed by the conventional technique described above is that in the case where a device (for example, the interrupt controller described above) with a frequently used register to be protected is virtualized, the protection exception handling amount is increased to such a degree as not negligible as compared with the processing amount of the system as a whole.

### SUMMARY OF THE INVENTION

This invention has been achieved in view of the problems of the prior art described above and the object thereof is to provide a virtual machine system and a virtual machine system control method adapted to reduce the protection exception handling of the virtualized device.

According to this invention, there is provided a virtual machine system including plural virtual machines sharing at least one CPU and one memory to execute plural programs by switching and a virtual machine control means for controlling the virtual machines,

wherein the virtual machine control means includes a protection holding means for storing a protected address to determine whether an exception is generated or not, and a structure of decoded instruction (or protection exception holding means) for storing a reusable optimized emulated code for the protection exception process,

wherein in the case where the program executed by the CPU reads from or writes into a specified address region, the virtual machine control means determines whether the protection exception process is to be executed or not with reference to the protection holding means, and in the case where the protection exception process is executed, determines whether the cause of the protection exception due to the address exists in the structure of decoded instruction for storing the reusable optimized emulated code for the protection exception process, while in the presence of a reusable optimized emulated code in the structure of decoded instruction, the protection exception process is executed using the optimized emulated code.

According to this invention, the unrequired emulated code process and the instruction analysis process can be reduced in the device operation of the real machine, or especially, the emulated code process and the instruction analysis process can be remarkably reduced in the virtualization of the device with a frequently used register to be protected.

### BRIEF DESCRIPTION OF THE DRAWINGS

FIG. 1 is a block diagram showing the configuration of a virtual machine system according to an embodiment of the invention.

FIG. 2 is a diagram for explaining the program to realize the virtual machine.

FIG. 3 is a flowchart for explaining the processing operation in the protection exception process to which the invention is not applicable.

FIG. 4 is a flowchart for explaining the processing operation in the protection exception process to which the invention is applicable.

### DETAILED DESCRIPTION OF THE INVENTION

Embodiments of the virtual machine system and the control method of the virtual machine system according to this invention are described in detail below with reference to the drawings.

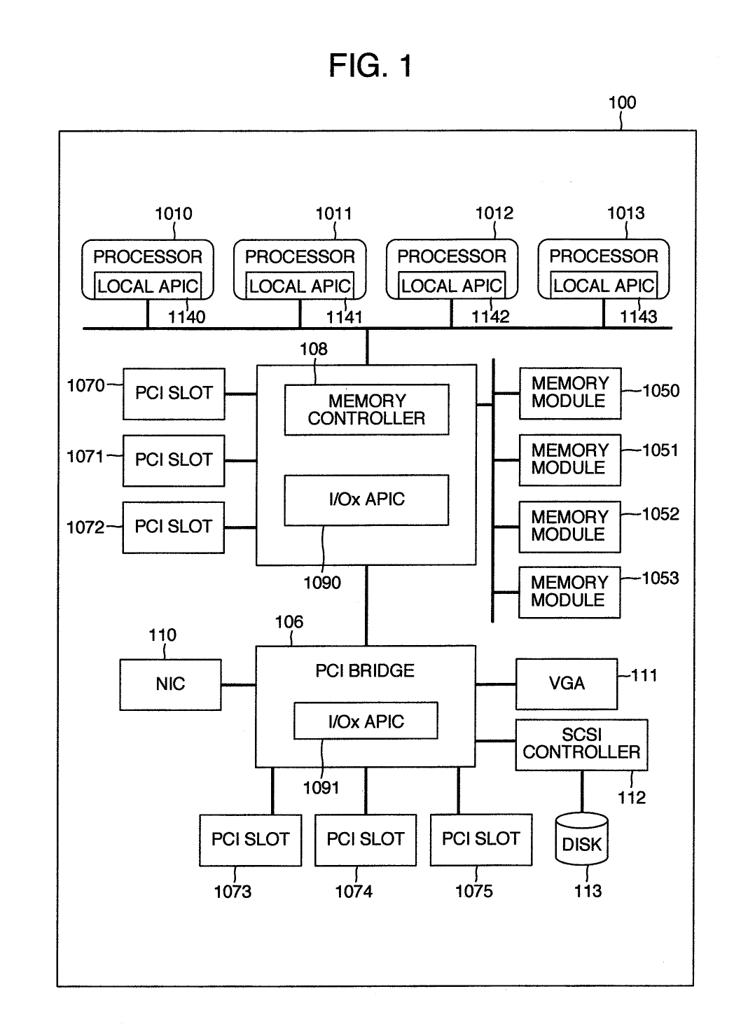

FIG. 1 is a block diagram showing the configuration of a virtual machine system according to an embodiment of the invention. The system shown in FIG. 1 represents a configuration of a real machine 100 including plural virtual machines and a virtual machine manager.

The real machine 100 accommodates plural processors 1010 to 1013. Any number of processors more than one can be accommodated. These processors 1010 to 1013 include local APICs (interrupt handling control units) 1140 to 1143, respectively. The processors 1010 to 1013 are connected to a device controller 103 by a system bus 102. The device controller 103 is configured of a memory controller 108 and an I/OxAPIC (I/O interrupt control unit) 1090 and has the function of arbitrating and controlling the interrupt and exchanging data between memory modules 1050 to 1053 and a PCI bridge 106. The memory modules 1050 to 1053 connected to the device controller 103 through the memory bus 104 constitute a main storage unit for storing the virtual machine manager and the programs on the virtual machines.

PCI slots 1070 to 1075 are connected to the device controller 103 or the PCI bridge 106. The PCI slots 1070 to 1075 are vacant slots for connection with an external extension device. Also, the PCI bridge 106 contains therein an I/OxAPIC (I/O interrupt unit) 1091. This I/OxAPIC 1091 has the function of applying the interrupt to the local APICs 1140 to 1143 from the devices connected to the device controller 103 or the PCI bridge 106. The PCI bridge 106 is connected not only with the PCI slots 1073 to 1075 but also with a VGA 111 constituting a video graphics array, a NIC 110 making up a network interface controller and a SCSI controller 112. The SCSI controller 112 is connected with a disk 113 for storing the program.

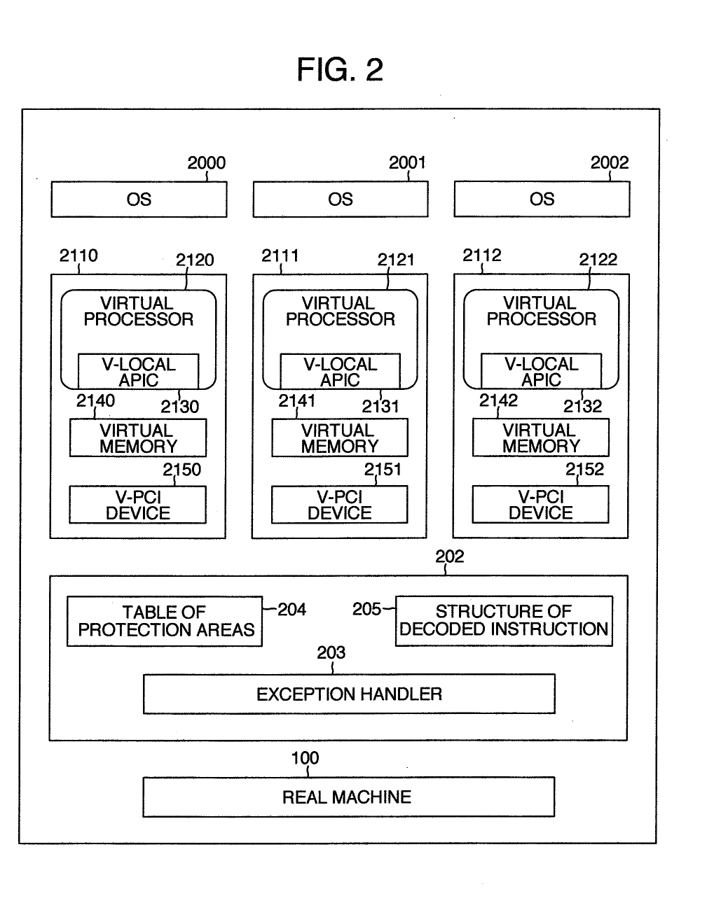

FIG. 2 is a diagram for explaining the program for implementing the virtual machine as described below.

Each of the virtual machines 2110 to 2112 configured in the real machine 100 is controlled by the virtual machine manager 202. OSes 2000 to 2002 can operate independently of each other on the virtual machines 2110 to 2112, respectively. The virtual machines 2110 to 2112 are each configured of virtual devices assigned by the virtual machine manager 202. These virtual devices, as viewed from the OSes 2000 to 2002 operating on the virtual machines, operate equivalently to the physical devices provided by the real machine 100. The virtual machines 2110 to 2112 are configured of virtual processors 2120 to 2122 having V-Local APICs (virtual interrupt control units) 2130 to 2132, virtual memories 2140 to 2142 and V-PCI devices 2150 to 2152, respectively. The virtual processors 2120 to 2122, the V-Local APICs (virtual interrupt control units) 2130 to 2132, the virtual memories 2140 to 2142 and the V-PCI devices 2150 to 2152 are virtual devices.

To the OSes 2000 to 2002, the virtual processors 2120 to 2122 appear to operate substantially equivalently to the processor 1010 of the real machine 100. The V-Local APICs 2130 to 2132, the virtual memories 2140 to 2142 and the V-PCI devices 2150 to 2152 also provide the OSes 2000 to 2002 with the operation equivalent to the external extension devices mounted on the local APICs 1140 to 1143, the memory modules 1050 to 1053 and the PCI slots 107, respectively, of the real machine 100.

The virtual devices described above correspond to the addresses assigned to the virtual machine manager 202. The virtual machine manager 202 has a table 204 of protected areas, determines whether the assigned address is used as a protected address or not, and defines it in the table 204 of protected areas. Also, the virtual machine manager 202 has a protection exception process 203, so that the program operating on the virtual machine generates an protection exception interrupt when accessing the virtual devices assigned to the protected address thereby to access the protection exception process 203. Further, the virtual machine manager 202 has a protection exception holding region 205 for holding the reusable optimized emulated code for the protection exception process.

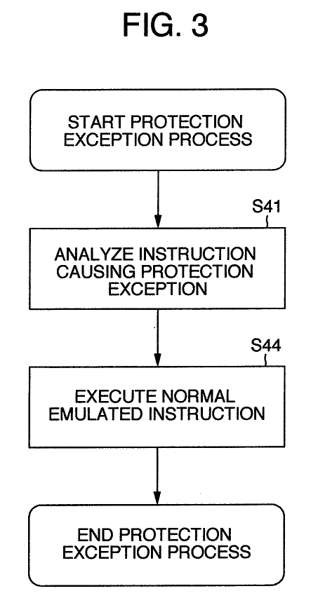

FIG. 3 is a flowchart for explaining the operation of the protection exception process in a case to which the invention is not applicable. Next, this flowchart is explained. The flow of the processes described herein is the conventional one for explaining the effects of the invention.
(1) Upon occurrence of a protection exception, the reference address that has caused the protection exception is delivered to the protection exception processing program to start the protection exception process. Then, the analysis of the instruction that has caused the protection exception is executed. Specifically, in the read operation, the number of read bytes and the destination where the read result is held are analyzed, while in the write operation, the number of write bytes and the data source of the write operation are analyzed. Also, in the instruction analysis, the instruction is specified, and the address designated for the instruction and the instruction length are analyzed in accordance with an analysis instruction (step S41).
(2) Next, referring to the analysis result, the normal process is executed as a emulated code execution. In this emulated code execution process, the virtualization process for each virtual device corresponding to the reference address, not shown, included in the protection exception process 203 is accessed and executed (step S44).

The process described above virtualizes the operation for the virtual devices thereby to realize the virtual devices.

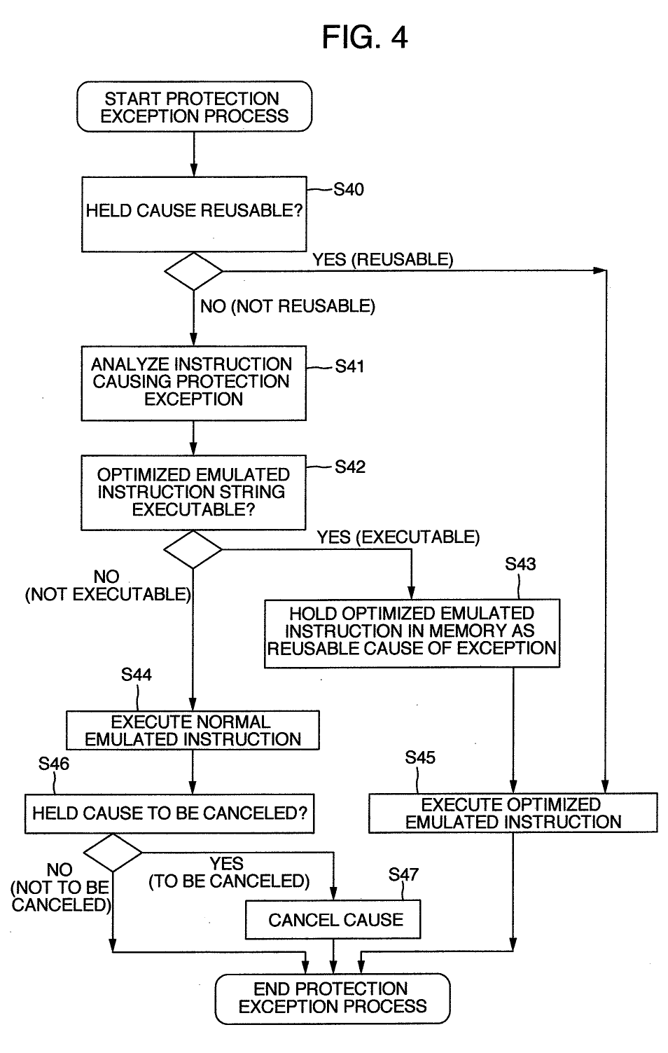

FIG. 4 is a flowchart for explaining the operation of the protection exception process to which the invention is applicable. This flowchart is explained below.
(1) In the same manner as explained with reference to FIG. 3, upon occurrence of a protection exception, the reference address that has caused the protection exception is delivered to the protection exception processing program to start the protection exception process. Then, judging whether the reference address is an instruction located at the address that has never been accessed or executed thus far, i.e. whether the cause held is reusable or not, assume that the cause is judged as reusable. Then, the optimized emulated code held in the protection exception holding region 205 is executed and the process is ended (steps S40, S45).
(2) In the case where step S40 judges that the reference address is an instruction located at the address that has thus far never been accessed or executed and the cause held is not reusable, the instruction that has caused the protection exception is analyzed in the same manner as in step S41 explained with reference to FIG. 3, while at the same time judging whether or not the emulated code which is obtained by converting the analysis result and the result of evaluation of the device address and the function at the particular address can be executed as an optimized emulated code and required to be held (steps S41, S42).
(3) In the case where step S42 judges that the emulated code obtained by the instruction analysis in step S41 is executable and required to be held as the optimized emulated code, the optimized emulated code is held in the protection exception holding region 205 as a reusable cause of exception, and the particular optimized emulated code is executed thereby to end the process (steps S43, S45).
(4) In the case where step S42 judges that the emulated code obtained by the instruction analysis in step S41 is not executable as the optimized instruction, on the other hand, the normal emulated code as in the process of step S43 in the flowchart of FIG. 3 is executed (step S44).
(5) After step S44, it is judged whether the cause held in the protection exception holding region 205 is to be canceled or not, and the particular cause, if judged to be canceled, is canceled and deleted from the protection exception holding region 205 and the process is ended, while in the case where the cause is not to be canceled, on the other hand, the process is ended as it is. Incidentally, the process of judging whether the cause held is to be canceled or not is described in detail later (steps S46, S47).

In the flowchart of FIG. 4 described above, the cause held in the protection exception holding region 205 by the process of step S43 is identical with the analysis result in the process of step S41 since the meaning of the instruction remains unchanged as long as the instruction is not rewritten or the address of the virtual device accessed by the instruction ceases to indicate the virtual device, and therefore, the cause is reusable as the result of analysis in the process of step S41. In such a case, step S40 judges that the cause held is reusable. In the case where the cause is not reusable, on the other hand, the cause held is canceled so that step S40 judges that the cause is not reusable. The process in the flowchart of FIG. 4 is executed also to detect that the cause held has become impossible to reuse.

Next, the process of judging that the cause held is not reusable is explained. In order to detect the rewriting of the instruction which becomes not reusable in this process, the place of the instruction address held in the protection exception holding region 205 is added to the table 204 of protected areas as a protected address. At the time of writing in the instruction address added to the table 204 of protected areas, the process in the flowchart of FIG. 4 is executed. In the process, after execution of step S44 in the flowchart of FIG. 4, step S46 compares the result of the instruction analysis by the process of step S41 in the flowchart of FIG. 4 with the instruction address held in the protection exception holding region 205. This comparison detects whether the write operation is performed or not in the instruction address related to the cause of exception that has been held. Also, in a manner similar to the detection of the instruction rewrite operation, a case is detected in which the address indicating the virtual device related to the cause of exception that has been held ceases to indicate the particular virtual device. Specifically, the address indicating the table held in each of the OSes 2001 to 2003 shown in FIG. 2 as the correspondence between the virtual device and the address indicating the virtual device is additionally registered in the table 204 of protected areas. In this way, the process of step S46 detects, in the manner similar to the detection of the instruction rewrite operation, that the address that has thus far indicated the virtual device has ceased to indicate the particular virtual device. At the same time, upon detection that the cause held is not reusable, the particular cause is canceled by the process of step S47.

As described above, according to an embodiment of the invention, the process of steps S41 and S44 in the flowchart of FIG. 4 can be omitted for a specified virtual device, and the control can be passed immediately to the process of step S45 to execute the specified function in the optimized virtual device. As a result, according to an embodiment of the invention, the total processing amount can be reduced in the case where the time used for the instruction analysis in step S41 is controlling in the process of the flowchart shown in FIG. 4. This effect can be enjoyed especially greatly for the parts of the virtual device which are repeatedly accessed.

The process according to the embodiment of the invention described above is configured of programs and can be executed by the CPU included in the invention. Also, these programs can be provided in the form stored in the recording medium such as FD, CD-ROM or DVD or as digital information through a network.

As described above, according to the embodiments of the invention, the protection exception process for realizing the virtual device provided by the virtual machine manager can be reduced. Therefore, this invention is effectively applicable to the virtualization of Local APIC employed in the x86-compatible architecture. The “End of Interrupt (EOI)” register of Local APIC is written so frequently that step S40 in the flowchart of FIG. 4 often judges that the register is a reusable cause, thereby making it possible to save the instruction analysis in step S41 involving a large processing amount. Also, in the application of this invention to the virtualization of Local APIC, the fact that only the four-byte write operation is significant and that the written value is always the same and not significant in the operation of the EOI register makes possible the execution of the simplified emulated code in step S45 but not the strict execution of the instruction such as the normal emulated code in step S44. Also, as long as the OS is in operation, it rarely occurs that the instruction for executing the EOI register is rewritten or the table held by each of the OSes 2001 to 2003 in FIG. 2 showing the correspondence between the EOI register and the address thereof is rewritten. As a result, the cause held is reused so frequently that the protection exception process of Local APIC packaged as a virtual device can be greatly reduced. In addition, the application of the invention to the I/O register or the like accessed by the frequently-accessed memory mapped IO makes it possible to reduce the protection exception process.

It should be further understood by those skilled in the art that although the foregoing description has been made on embodiments of the invention, the invention is not limited thereto and various changes and modifications may be made without departing from the spirit of the invention and the scope of the appended claims.

1. A virtual machine system configured of a plurality of virtual machines sharing at least one CPU and at least one memory and adapted to be switched to execute a plurality of programs, comprising:
a virtual machine control means for controlling the virtual machines;
wherein the virtual machine control means includes a protection holding means for storing a protected address to determine whether an exception is to be generated or not and an structure of decoded instruction for storing a reusable optimized emulated code for a protection exception process;
wherein the virtual machine control means, by accessing the protection holding means, determines whether the protection exception process is to be executed or not at the time of the read operation or the write operation performed for a specified address region by the program executed by the CPU, and in the case where the protection exception process is executed, the virtual machine control means judges whether the cause of the protection exception due to the address exists in the structure of decoded instruction for storing the reusable optimized emulated code for the protection exception process, while in the case where the reusable optimized emulated code exists in the structure of decoded instruction, the protection exception process is executed using the particular optimized emulated code.

2. The virtual machine system according to claim 1,
wherein in the case where the reusable optimized emulated code for the protection exception process is not existent in the structure of decoded instruction, the virtual machine control means analyzes the instruction causing the protection exception, and judges whether the emulated code obtained by converting the analysis result and the result of evaluation of the device address and the function of the particular address is executable as an optimized emulated code and required to be held for reuse, and in the case where the emulated code is required to be held, holds the optimized emulated code in the structure of decoded instruction and executes the protection exception process using the particular optimized emulated code.

3. The virtual machine system according to claim 2,
wherein in the case where the emulated code obtained from the result of the instruction analysis is not executable as an optimum emulated code and not required to be held for reuse, the virtual machine control means accesses the analysis result and executes the normal emulated code execution thereby to execute the protection exception process.

4. The virtual machine system according to claim 3,
wherein upon detection based on the instruction analysis result that the optimized emulated code held in the structure of decoded instruction is not reusable, the virtual machine control means cancels the optimized emulated code held in the structure of decoded instruction.

5. A control method for a virtual machine system configured of a plurality of virtual machines sharing at least one CPU and at least one memory to execute by switching a plurality of programs;
wherein the virtual machine system comprises a virtual machine control means for controlling the virtual machines, and
wherein the virtual machine control means includes a protection holding means for storing a protected address to determine whether an exception is to be generated or not and an structure of decoded instruction for storing a reusable optimized emulated code for a protection exception process;
wherein the virtual machine control means, by accessing the protection holding means, determines whether the protection exception process is to be executed or not at the time of the read or the write operation performed from or into a specified address region by the program executed by the CPU, and in the case where the protection exception process is executed, the virtual machine control means judges whether the cause of the protection exception due to the address exists in the structure of decoded instruction for storing the reusable optimized emulated code for the protection exception process, while in the case where the reusable optimized emulated code exists in the structure of decoded instruction, the protection exception process is executed using the particular optimized emulated code.

6. The control method for the virtual machine system according to claim 5,
wherein in the case where the reusable optimized emulated code for the protection exception process is not existent in the structure of decoded instruction, the virtual machine control means analyzes the instruction causing the protection exception, and judges whether the emulated code obtained by converting the analysis result and the result of evaluation of the device address and the function of the particular address is executable as an optimized emulated code and required to be held for reuse, while in the case where the emulated code is required to be held, the virtual machine control means holds the optimized emulated code in the structure of decoded instruction and executes the protection exception process using the particular optimized emulated code.
